(19) United States
(12) Patent Application Publication
(10) Pub. No.: US 2017/0205258 A1
(43) Pub. Date: Jul. 20, 2017

(54) TEST FIXTURE, SYSTEM AND METHOD FOR CONCENTRICITY MEASUREMENT TOOL CALIBRATION

(71) Applicant: General Electric Company, Schenectady, NY (US)

(72) Inventors: Piotr Krzysztof Dzieciol, Warsaw (PL); Paul Howard Davidson, Albany, NY (US); Szymon Perkowski, Warsaw (PL)

(21) Appl. No.: 15/140,669

(22) Filed: Apr. 28, 2016

(30) Foreign Application Priority Data
Jan. 14, 2016 (PL) 415800

(51) Int. Cl. G01D 18/00

(52) U.S. Cl. CPC G01D 18/00

(57) ABSTRACT

A test fixture, system and method are provided for concentricity measurement tool calibration. A test fixture may include a rotor simulating member including a rotor mount; a stator simulating member including a stator mount; an adjustable positioner for positioning the rotor simulating member and the stator simulating member in a selected one of a plurality of predetermined concentricity positions relative to one another; and a support for positioning the rotor simulating member and the stator simulating member on the ground. The test fixture can be used to calibrate concentricity measurement tool, such as an electronic radial alignment gauge, prior to use and/or in situations where the actual rotor or stator have not been manufactured.

### BACKGROUND OF THE INVENTION

The disclosure relates generally to measurement equipment calibration, and more particularly, to test fixture and system for calibrating a concentricity measurement tool, and related method.

Rotary industrial machines include rotors and stators that require concentricity in order to operate correctly. Illustrative rotary industrial machines include jet engines, compressors, gas turbines, steam turbines, motors, generators, combustion engines, transmissions, etc. For turbines, the rotor includes a number of turbine blade stages encircled by a stationary diaphragm that creates a working fluid passage. As the working fluid flows through the working fluid passage, it forces the turbine blades to turn the rotor. Typically, the rotor and diaphragm must be concentric for the turbine to work properly.

Concentricity measuring tools, such as an electronic radial alignment gauge (ERAG) and similar tools, are used to measure concentricity deviations in industrial machines. In operation, the radial alignment measuring tools are configured to be positioned between the stator and the rotor and measure a distance therebetween at a number of circumferential locations so as to identify non-concentricity between the parts. Stators and rotors can come in a large variety of configurations in terms of, for example, radial spacing, outer radii, mating surface structure such as circumferential seals and/or ridges, etc. The large variety of stator/rotor configurations necessitates a large number of different measurement tools, e.g., in terms of size, shape, measurement technique, etc. Typically, concentricity requirements are evaluated during both installations and outages of turbines.

One challenge in the concentricity measurement process relates to calibrating the tools for a particular industrial machine. In particular, systems to calibrate the tools outside of doing so in the field and on the actual industrial machine are not currently available. Calibrating the tools in the field and/or on the actual industrial machine is normally not ideal because the inherent inaccuracy created by the situation, i.e., calibrating a measurement tool in the same environment in which it will be employed. Advances in technology that change the rotor and/or stator, such as new sealing technology/geometry in turbines, magnifies the calibration challenge because the industrial machine to which the tool is to be applied may not exist. In this case, calibrating the radial alignment measurement tool may be impossible until the machine is manufactured.

### BRIEF DESCRIPTION OF THE INVENTION

A first aspect of the disclosure provides a test fixture, comprising: a rotor simulating member including a rotor mount; a stator simulating member including a stator mount; an adjustable positioner for positioning the rotor simulating member and the stator simulating member in a selected one of a plurality of predetermined concentricity positions relative to one another; and a support for positioning the rotor simulating member and the stator simulating member on the ground.

A second aspect of the disclosure provides a system for calibrating a radial alignment gauge configured to measure a concentricity deviation between a stator and a rotor of a turbomachine, the system comprising: a test fixture including: a rotor simulating member including a rotor mount, a stator simulating member including a stator mount, an adjustable positioner for positioning the rotor simulating member and the stator simulating member in a selected one of a plurality of predetermined concentricity positions relative to one another, and a support for positioning the rotor simulating member and the stator simulating member on the ground; and a controller configured to calibrate the radial alignment gauge using the text fixture.

A third aspect of the disclosure provides a method for calibrating a concentricity measurement tool configured to measure a concentricity deviation between a stator and a rotor of a rotary industrial machine, the method comprising: measuring, at a selected circumferential position and using the radial alignment gauge, a distance between a rotor simulating member and a stator simulating member that are positioned in a selected one of a plurality of predetermined concentricity positions relative to one another, each predetermined concentricity position creating a predetermined distance between the rotor simulating member and the stator simulating member at the selected circumferential position; determining an amount of deviation between the distance measured and the predetermined distance; and calibrating the radial alignment gauge using the amount of deviation.

The illustrative aspects of the present disclosure are arranged to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective view of a test fixture and system according to embodiments of the disclosure.

FIG. 2 shows a perspective view of a right end of the test fixture as denoted in FIG. 1.

FIG. 3 shows a side view of the test fixture of FIG. 1 with a rotor mount removed.

FIG. 4 shows a side view of a left end of the test fixture as denoted FIG. 1 with a number of enlarged details.

FIG. 5 shows a perspective view of a first side, left end of the test fixture as denoted in FIG. 1.

FIG. 6 shows a perspective view of a second side, left end of the test fixture as denoted in FIG. 1.

FIG. 7 shows a perspective view of a first side, right end of a test fixture according to an alternative embodiment of the disclosure.

FIG. 8 shows a side view of the test fixture of FIG. 7.

FIG. 9 shows a perspective view of a first side, right end of a test fixture according to another alternative embodiment of the disclosure.

FIG. 10 shows a cross-sectional, enlarged view of a fastener used with various embodiments of the disclosure in a loosened state.

FIG. 11 shows a cross-sectional, enlarged view of the fastener of FIG. 10 in a tightened state.

FIGS. 12 and 13 show perspective views of a couple of concentricity measurement tools in use with a test fixture according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, the disclosure provides a test fixture, system and method for calibrating a concentricity measurement tool.

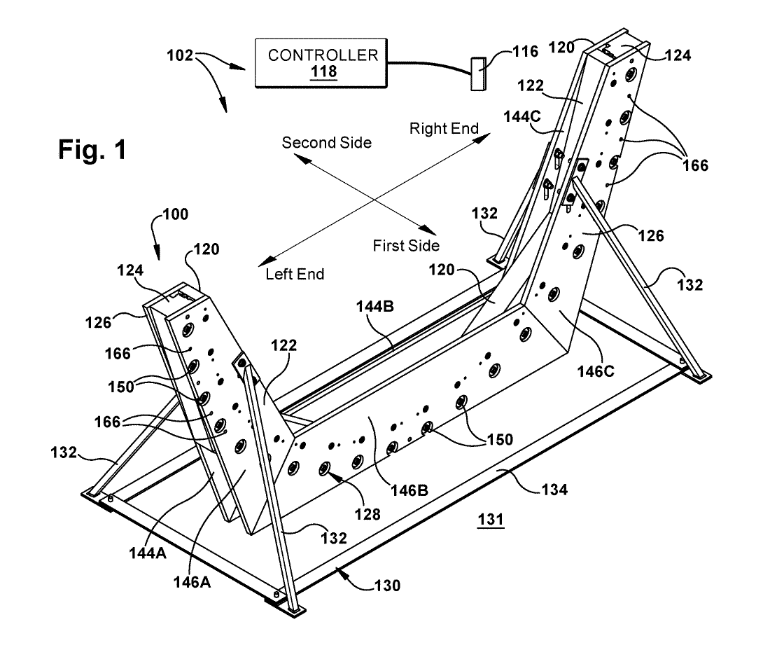

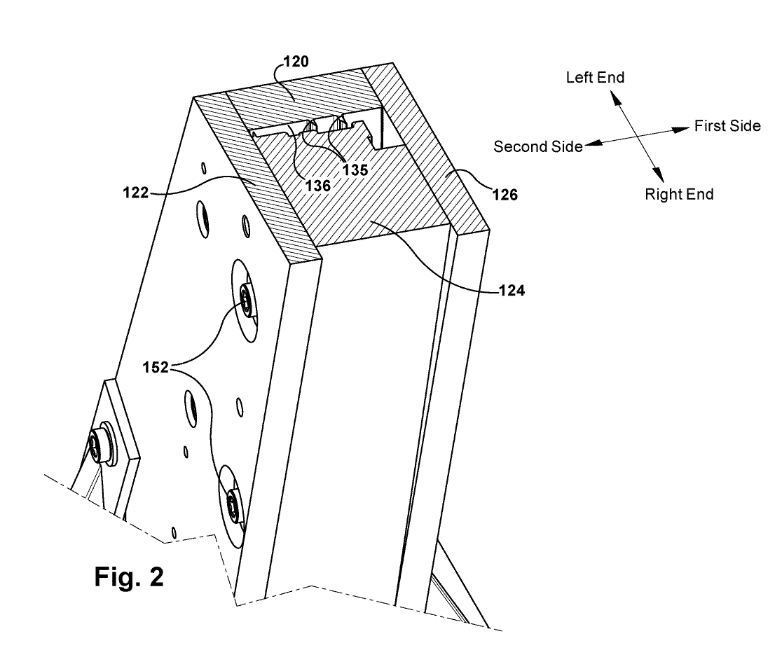

FIG. 1 shows a perspective view of a test fixture 100 and system 102 according to embodiments of the invention. FIG. 2 shows a perspective view of an end of test fixture 100. For purposes of description, test fixture will be referenced herein as denoted by the directional arrows in FIG. 1, with a first side and second side, and a left end and a right end. It is emphasized that the first, second, right, left notations are for providing reference through the various drawings, and are not meant to limit the disclosure. Generally, test fixture 100 may include a rotor simulating member 120 and a stator simulating member 124. As indicated by the shading in FIG. 2, rotor simulating member 120 may include a rotor mount 122, and stator simulating member 124 may include a stator mount 126. As will be described, an adjustable positioner 128 positions rotor simulating member 120 and stator simulating member 124 in a selected one of a plurality of predetermined concentricity positions relative to one another.

System 102 may also include a concentricity measurement tool 116 (FIG. 1 only) to measure a radial alignment between simulating members 120, 124. Using test fixture 100 and system 102, measurement tool 116 can be calibrated for use on a rotary industrial machine simulated by test fixture 100. The teachings of the invention may be applied to any form of measurement tool 116 for measuring a radial alignment or, in other words, concentricity, between rotor and stator simulating members 120, 124 of test fixture 100. For example, the concentricity measurement tool may include an electronic radial alignment gauge such as those disclosed in U.S. application Ser. No. 14/875,024, GE docket number 281700, and U.S. application Ser. No. 14/953,173, GE docket number 281703, currently pending, each of which are incorporated herein by reference. Concentricity measurement tool 116 (hereinafter “measurement tool 116”) can use a wide variety of measurement techniques such as but not limited: induction, laser, impedance, etc. System 102 and measurement tool 116 may also include a controller 118 configured to measure a distance between stator simulating member 124 and rotor simulating member 120, calculate a concentricity deviation between the members based on a number of measurements, and calibrate the tool based on the methods described herein using test fixture 100. Concentricity deviation can be calculated based on a known separation of stator and rotor simulating members at a particular circumferential position as set by test fixture 100 and a measured distance, as will be described herein. Controller 118 may include any now known or later developed industrial controller capable of providing the functionality described herein.

As shown in FIG. 1, test fixture 100 may also include a support 130 for positioning rotor simulating member 120 and stator simulating member 124 on a fixed surface 131 such as the ground or work shop floor. Support 130 may include a plurality of adjustable support legs 132 adjustably coupled to respective mounts 122 or 126, e.g., by bolts/nuts in a slotted opening in the mounts. A leg holding member 134 may be employed to hold legs 132 in a lateral position relative to one another, but may not be necessary in all cases.

Each simulating member 120, 124 is configured to represent a respective rotor or stator in a rotary industrial machine upon which a measurement tool 116 would be used to measure radial alignment or in other words concentricity of the parts. For example, rotor simulating member 120 may represent a rotor of a gas or steam turbine, and stator simulating member 124 may represent a diaphragm of the gas or steam turbine. In another example, members 120, 124 may represent any rotating (rotor) and stationary (stator) parts, respectively, of practically any rotary industrial machine including but not limited to: a jet engine, a compressor, a motor, a generator, a combustion engine, a transmission, etc. As shown best in FIG. 2, each member 120, 124 may also include a feature(s) 135, 136 of the rotor or stator, respectively, that they are to represent. Features 135, 136 can take a variety of forms, such as but not limited to a seal simulating groove to represent: brush seals, abrade-able seals, grooves, seats, ledges, surfaces, raised areas, etc. Depending on the type of stator and/or rotor, a wide variety of features 135, 136 are possible. To this end, each member 120, 124 may include a set of members, each providing a different configuration to represent a variety of different rotary industrial machines of a particular type. For example, different stator simulating members may include different arrangements of seal seats, grooves, surfaces, etc., and different rotor simulating members may include different seals, seats, etc. In another example, different sets of simulating members may have different outer diameter rotors or different internal diameter stators, each of which may have different radial alignment distances.

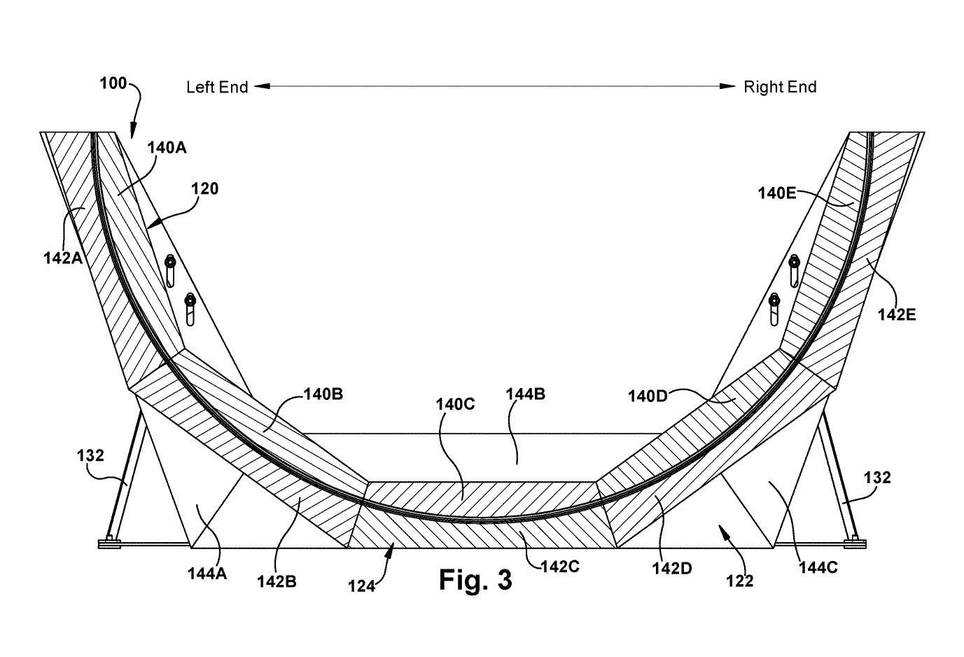

FIG. 3 shows a first side view of test fixture 100 with rotor mount 126 (FIG. 2) removed. In the embodiments illustrated, test fixture 100 represents approximately 180° of the rotary industrial machine. It is emphasized, however, that test fixture 100 may provide more or less of the simulated device, if desired, i.e., 120°, 90°, etc. As used herein, “approximately” indicates +/−10% of the stated value, and may be applied to either the upper or lower end of a range, if presented in that fashion.

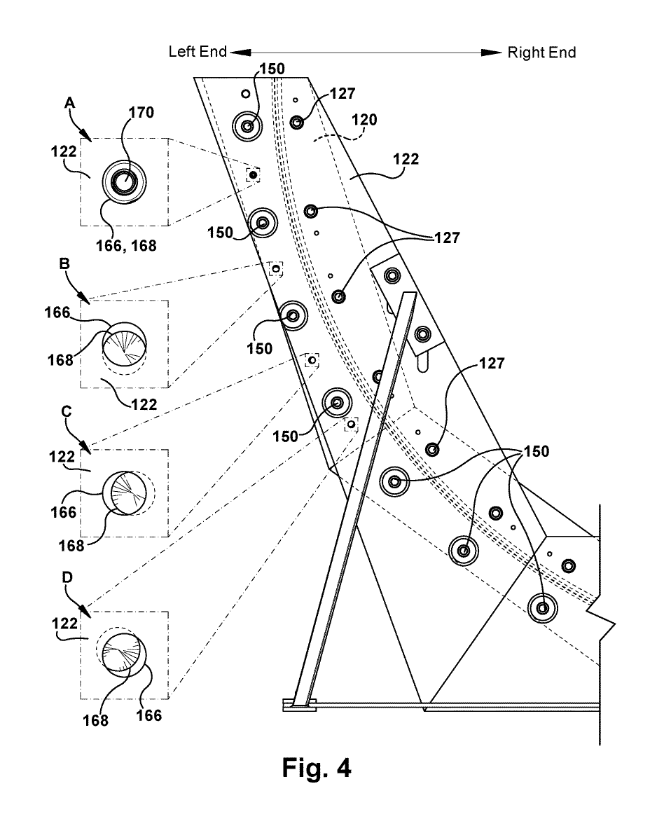

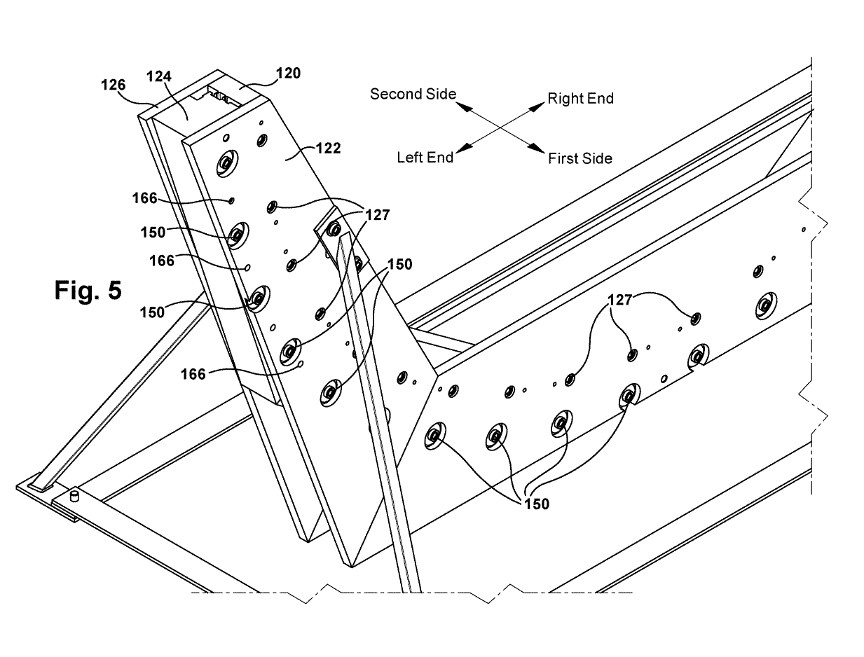

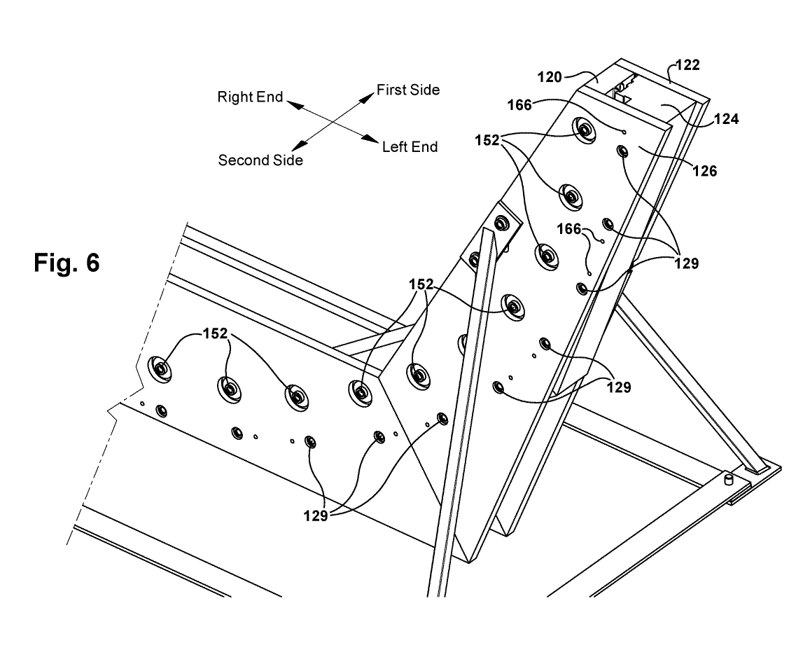

FIG. 4 shows a detailed, enlarged first side, left end view of test fixture 100 as denoted in FIG. 1, FIG. 5 shows a perspective view of the left end, first side of test fixture 100 (i.e., with rotor mount 122 in front as in FIG. 1), and FIG. 6 shows a perspective view of the left end, second side of test fixture 100 (i.e., with stator mount 126 in front). As shown best in FIGS. 4 and 5, rotor simulating member 120 may include rotor mount 122. Member 120 and mount 122 may be formed as integral part or may be fixedly coupled together by, for example, a number of threaded fasteners 127 or other fastening means such as welding. Similarly, as shown best in FIG. 6, stator simulating member 124 may include stator mount 126. Member 124 and mount 126 may be formed as integral parts or may be fixedly coupled together by, for example, a number of threaded fasteners 129 or other fastening means such as welding. In one embodiment, each mount 122, 126 may be provided as a plate or planar member. Each threaded fastener 127, 129 threadably connects a respective mount to a corresponding simulating member. A number of dowels (small holes between fasteners 127, 129) may be employed between mounts 122, 126 and mating simulating members 124, 120, respectively, to assist in alignment.

As shown best in FIG. 3, each simulating member 120, 124 may be formed of a plurality of segments that collectively represent a part of a respective simulated rotor or stator. For example, rotor simulating member 120 may include five segments 140A-E, and stator simulating member 124 may include five segments 142A-E, such that each simulating member includes five 36° segments, i.e., where each simulating member 120, 124 extends 180°. Each member's segments may be held in position by respective fasteners 127, 129 of their respective mounts. Any number of segments, including one, may be employed. Similarly, rotor mount 122 and stator mount 126 (FIGS. 1 and 2) may be segmented. Each mount's segments may be held in position by respective fasteners 127, 129 of their respective simulating member segments. In an example shown in FIGS. 1 and 3, each mount 122, 126 includes three segments, e.g., segments 144A-144 C of rotor mount 122 and segments 146A-C (FIG. 1 only) of stator mount 126. Any number of segments, including one, may be employed. In one embodiment, certain portions of mounts 122, 126 may have a portion that is substantially planar to allow positioning on fixed surface 131 (e.g., the ground). In the example shown in FIG. 1, segments 144B, 146B are planar such that they sit evenly on fixed surface 131. Other arrangements are also possible. Simulating members 120, 124, mounts 122, 126 and support 130 can be made of any suitable metal capable of providing their stated function, e.g., steel, steel alloy, aluminum, aluminum alloy, etc. Segments 140A-E, 142A-E, 144A-C and/or 146A-C, when used, can be welded together in addition to coupling by fasteners 127, 129.

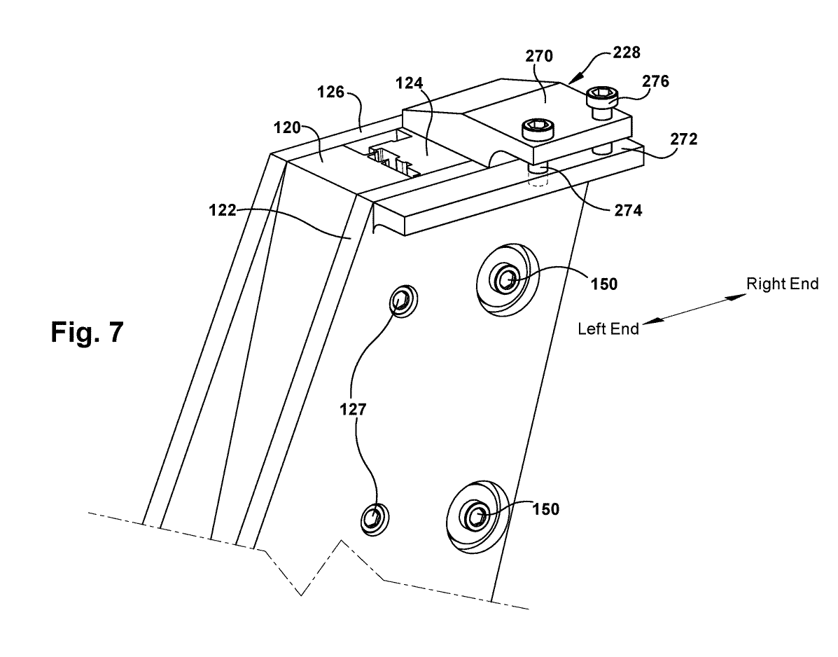

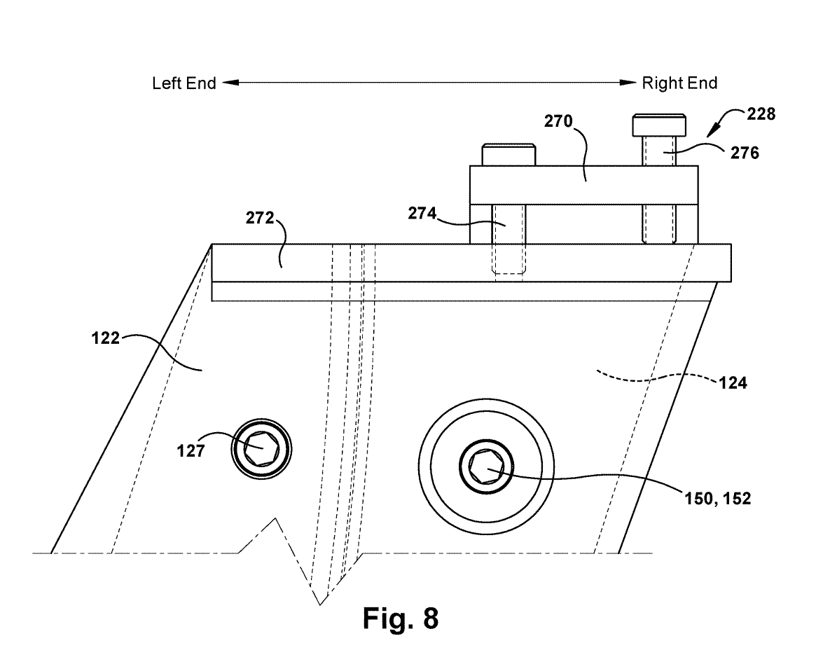

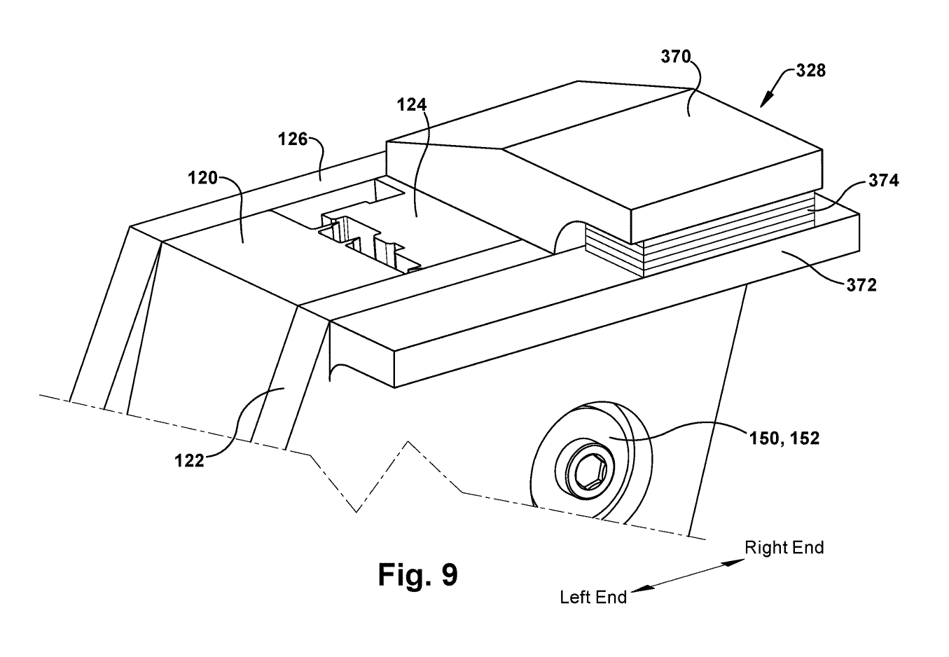

Test fixture 100 and system 102, as noted herein, also provide an adjustable positioner for positioning rotor simulating member 120 and stator simulating member 124 in a selected one of a plurality of predetermined concentricity positions relative to one another. The adjustable positioner can take a variety forms illustrated in FIGS. 1 and 4-9. FIGS. 1 and 4-6 show one embodiment, FIGS. 7 and 8 show another embodiment, and FIG. 9 shows yet another embodiment. As will be described, the plurality of predetermined “concentricity positions” may include a concentric position between rotor simulating member 120 and stator simulating member 124, and at least one non-concentric position between rotor simulating member 120 and stator simulating member 124. A “concentric position” is one in which rotor and stator simulating members 120, 124 share the same center or axis. In other words, rotor simulating member 120 and stator simulating member 124 are radially aligned and are equidistant along their facing circumferential surfaces. A “non-concentric” position is one in which rotor and stator simulating members 120, 124 do not share the same center or axis, and are not radially aligned.

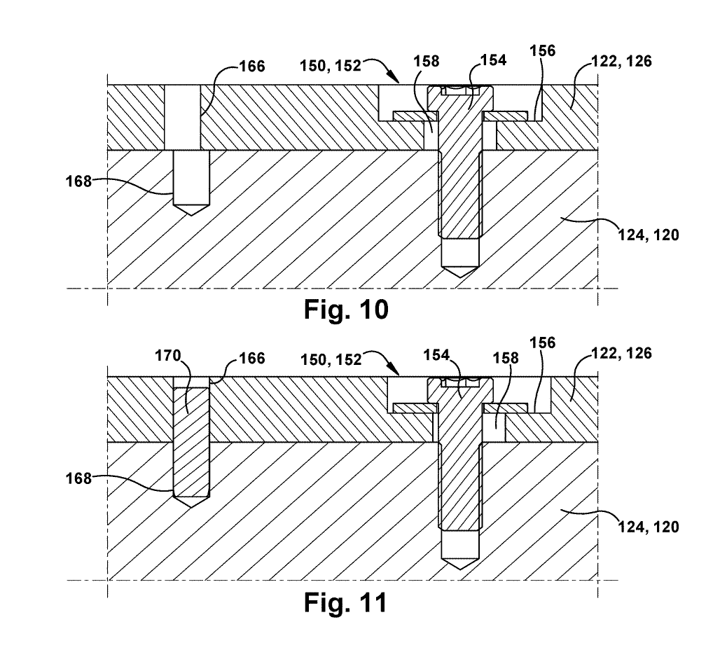

As will be described, the adjustable positioner can take a wide variety of forms. In the embodiments illustrated in FIGS. 1 and 4-9, and as shown best in FIG. 5, an adjustable positioner 128 may include a plurality of first fasteners 150 selectively fastening rotor mount 122 to stator simulating member 124, and as shown best in FIG. 6, a plurality of second fasteners 152 selectively fastening stator mount 126 to rotor simulating member 120. In this fashion, simulating members 120, 124 can be selectively coupled and de-coupled from each other. As shown in FIG. 10, each fastener 150, 152 may include a threaded fastener 154 positioned within a seat 156 of a respective mount 122, 126. Seat 156 may communicate with an opening 158 through which threaded fastener 154 extends to threadably engage a respective member 124, 120. Opening 158 and seat 156 are sufficiently large to allow mount 122, 126 to couple to a respective member 124, 120 with a predefined amount of lateral play. Once threaded fastener 154 is tightened, however, mounts 124, 120 and simulating members 122, 126 are fixed in position. Any form of washer may be employed, if necessary. Any number of fasteners 150, 152 may be employed to ensure proper locating of parts and the predefined amount of movement between members 120, 124 and respective mounts 126, 122. For example, a sufficient number of fasteners 150, 152 must be provided to ensure proper coupling and positioning of the different segments 140A-E and/or 142A-E (FIG. 3) of simulating members 120, 124 and segments 144A-C and 146A-C of mounts 122, 126, when they are provided in a segmented form.

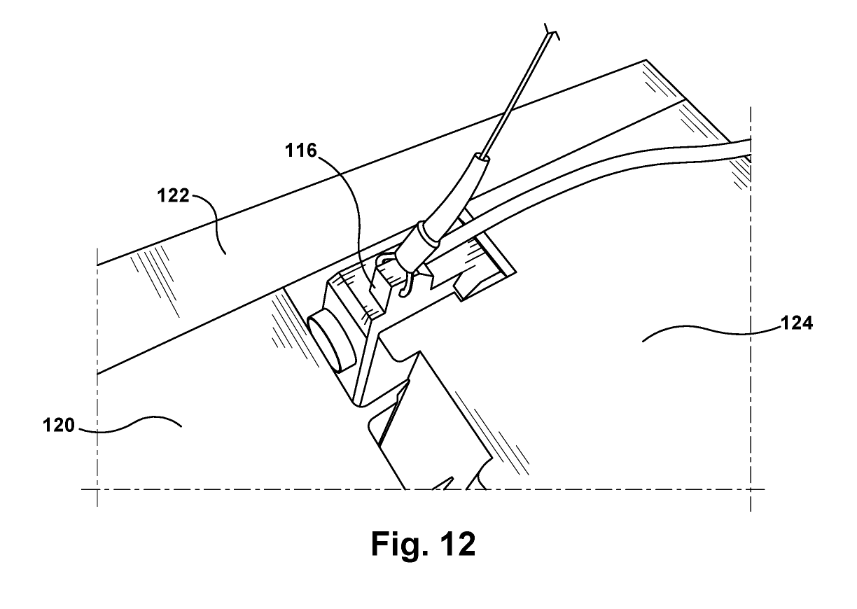

In one embodiment, shown in FIGS. 1, 4-6, 10 and 11, adjustable positioner 128 may also include a set of paired positioning openings 166, 168 in at least one of: a) stator simulating member 124 and rotor mount 122, and b) rotor simulating member 120 and stator mount 126. As shown best in FIGS. 4, 10 and 11, openings 166 are in mounts 122 and/or 126, and openings 168 are in simulating members 120 and/or 124. Loosening of fasteners 150 and/or 152 (FIG. 1), adjustment of position of simulating members 120, 122 relative to one another, and positioning of a positioning member 170, as shown in FIG. 4 (position A) and FIG. 11, in a selected pair of (aligned) paired positioning openings 166, 168 selects a selected one of the predetermined concentricity positions of rotor simulating member 120 and stator simulating member 124 relative to one another. That is, one pair of positioning openings 166, 168 in each set can be selected using a positioning member 170 to choose between a number of potential concentric positions provided by the set. Any number of paired positioning openings 166, 168 can be provided in each set to create the same number of concentric positions. Once a concentric position is selected, as shown in FIG. 11, fasteners 150 and/or 152 are tightened to hold the position.

Sets of paired openings 166, 168 can be provided in a wide variety of locations. For example, FIG. 1 shows sets of openings 166 in both left and right sides of rotor mount 122. Similarly, both right and left sides of stator mount 126 (FIG. 6, second side) may include sets of openings 166 in stator mount 126. That is, in one embodiment, more than one set of paired positioning openings 166, 168 may be provided, e.g., on opposing first and second sides (FIGS. 1, 5 and 6) of test fixture 100 and opposing right and left ends (FIG. 1) of test fixture 100. Here, four positioning members 170 may be employed, one for each set. More particularly, in FIGS. 1 and 4-6, for example, a first set of paired positioning openings 166, 168 (latter in FIG. 4 only) may be positioned in rotor mount 122 and stator simulating member 124, respectively, such that a position of stator simulating member 124 can be adjusted. The first set can be provided in both first and second ends of test fixture 100 on the first side, so stator simulating member 124 (all segments) can be adjusted in its entirety. Similarly, alone or at the same time as above, a second set of paired positioning openings 166, 168 (latter in FIG. 4 only) may be positioned in rotor simulating member 120 and stator mount 126, as shown in FIG. 6, such that a position of rotor simulating member 120 can also be adjusted. The second set can be provided in both first and second ends of test fixture 100 on the second side, so rotor simulating member 120 (all segments) can be adjusted in its entirety. In any event, each set provides for coordinated positioning of simulating members 120, 122 in one of the plurality of concentric positions. That is, corresponding pairs of each set of paired positioning openings 166, 168 may cooperatively define the respective one of the plurality of predetermined concentricity positions of rotor simulating member 120 and stator simulating member 124 relative to one another. In this case, a first positioning member 170 would be used in the selected pair of the paired positioning openings in the first set and a second positioning member 170 would be used in the selected pair of positioning openings in the second set. Another two positioning members 170 could be used on the other side if the first and second sets are also provided on the other side.

It is emphasized that four sets of paired openings 166, 168 are not required as less sets may be employed, if desired. For example, two sets, one on each end on only one side of the test fixture 100 may be employed to move only one of the simulating members 120, 124. Alternatively, only one set of paired openings 166, 168 may be employed if it is desired to, for example, only move one segment 140A-E or 142A-E of the simulating members 120, 124, respectively, relative to the other segments. In this latter case, the concentricity position would just be dictated by the single set of paired openings. In any event, the number of fasteners 150, 152 that are required to be loosened is determined by the number of paired openings 166, 168 employed.

As noted, each pair of paired positioning openings 166, 168 defines a respective one of the plurality of predetermined concentricity positions of rotor simulating member 120 and stator simulating member 124 relative to one another, i.e., when aligned. Thus, positioning of a positioning member 170, as shown in FIG. 4 (position A) and FIG. 11, in a selected pair of (aligned) paired positioning openings 166, 168 selects a selected one of the predetermined concentricity positions of rotor simulating member 120 and stator simulating member 124 relative to one another. Positioning member 170 may include any rigid member such as but not limited to a dowel or bolt, capable of insertion in aligned pairs of paired positioning openings 166, 168. To clarify, as shown best in FIG. 4, each opening 166 in a mount 122, 126 (rotor mount 122 in FIG. 4) has a corresponding opening 168 in whatever simulating member 124, 120 (stator member 124 in FIG. 4) to which it is fastened by fasteners 150, 152 (150 in FIG. 4). When fasteners 150 are loosened, as shown in FIG. 10, rotor mount 122 can move relative to stator simulating member 124 such that paired openings 166, 168 therein can be aligned to select a predetermined concentricity position, e.g., by inserting positioning member 170 therein. Similarly, when fasteners 152 are loosened, as shown in FIG. 10, stator mount 126 can move relative to rotor simulating member 122 such that paired openings 166, 168 therein can be aligned to select a predetermined concentricity position, e.g., by inserting positioning member 170 therein. As noted, any number of paired openings 166, 168 can be created to provide any number of concentricity positions. In FIG. 4, an example set includes four pairs A-D of paired openings 166, 168 in rotor mount 122 and stator simulating member 124—openings 168 in stator simulating member 124 are visible through paired openings 166 in rotor mount 122. Some example concentricity positions may include but are not limited to: position A (shown with positioning member 170 therein) may provide the concentric position; position B may provide a rotor up 2 millimeter (mm) non-concentric position; position C may provide a rotor left 2 mm non-concentric position; and position D may provide a rotor 2 mm down non-concentric position. The non-concentric distances provided can vary depending on application. As shown in FIG. 11, once a position is selected by insertion of one or more positioning members 170 in paired openings 166, 168, the respective fastener(s) 150, 152 can be tightened to hold the position so measurement tool 116 can be used to measure the distance between simulating members 120, 124.

Referring to FIGS. 7 and 8, another embodiment of an adjustable positioner 228 is illustrated. FIG. 7 shows a perspective view of a first side, right end of test fixture 100 (FIG. 1), and FIG. 8 shows a right side view of the first side, right end of the test fixture of FIG. 7. It is noted that adjustable positioner 228 can be used on one or both ends of test fixture 100. In this embodiment, adjustable positioner 228 may include fasteners 150, 152, as described herein. In contrast to FIGS. 1 and 4-6, however, adjustable positioner 228 includes a first adjustment member 270 coupled to a selected one of rotor simulating member 120 and stator simulating member 124, and a second adjustment member 272 coupled to an opposing one of stator mount 126 and rotor mount 122 and in proximity to first adjustment member 270. As used here, “opposing” indicates that particular mount 122, 126 to which the particular simulating member 120, 124 is fastened by respective fasteners 150, 152. In FIGS. 7 and 8, for example, first adjustment member 270 is coupled to stator simulating member 124, and so second adjustment member 272 is coupled to opposing, rotor mount 122. In the example shown, first adjustment member 270 extends up and away from stator simulating member 124, second adjustment member 272 is coupled as a ledge extension from rotor mount 122 (bolted, welded, integral, etc.), and both adjustment members 270, 272 extend from first side as denoted in FIG. 1. It is emphasized, however, that adjustment members 270, 272 can extend from the second side. In this latter case, first adjustment member 270 may extend up and away from rotor simulating member 120, second adjustment member 272 may be coupled as a ledge extension from stator mount 126, and both adjustment members 270, 272 extend from a second side as denoted in FIG. 1—away or into page in FIGS. 7 and 8. As used here, “in proximity” means sufficiently close that positional adjusters can be used therebetween with relative ease.

Adjustable positioner 228 may further include a threaded distance adjuster 274 for selectively setting a distance between first adjustment member 270 and second adjustment member 272, and a threaded angle adjuster 276 for selectively setting an angle between first adjustment member 270 and second adjustment member 272. In the example shown, threaded distance adjuster 274 is coupled to first adjustment member 270 such that it can be threaded into second adjustment member 272 to adjust the distance therebetween. Threaded angle adjuster 276 is threaded into first adjustment member 270 and abuts second adjustment member 272 so as to angle first and second adjustment members 270, 272 relative to one another. Threaded distance adjuster 274 may limit the amount of angling provided by threaded angle adjuster 276. In any event, threaded distance adjuster 274 and threaded angle adjuster 276 cooperatively act to position rotor simulating member 120 and stator simulating member 124 in the selected one of a plurality of predetermined concentricity positions relative to one another.

FIG. 9 shows a perspective view of another adjustable positioner 328 according to embodiments of the disclosure. In this embodiment, adjustable positioner 328 may include fasteners 150, 152, as described herein, and a first adjustment member 370 coupled to a selected one of rotor simulating member 120 and stator simulating member 124, and a second adjustment member 372 coupled to an opposing one of stator mount 126 and rotor mount 122 and in proximity to first adjustment member 370. Adjustment members 370, 372 can take any form as described relative to the FIGS. 7-8 embodiment. In contrast to the FIGS. 7 and 8 embodiment, adjustable positioner 328 includes at least one shim 374 positioned between first adjustment member 370 and second adjustment member 372 to set a position of the rotor adjustment member relative to first adjustment member 370, and thus position rotor simulating member 120 and stator simulating member 124 in the selected one of a plurality of predetermined concentricity positions relative to one another. Shim(s) 374 may be planar so as to simply change a vertical position between simulating members 120, 124, or may include non-planar shims that also change an angle between simulating members 120, 124. Any number of shims 374 may be employed.

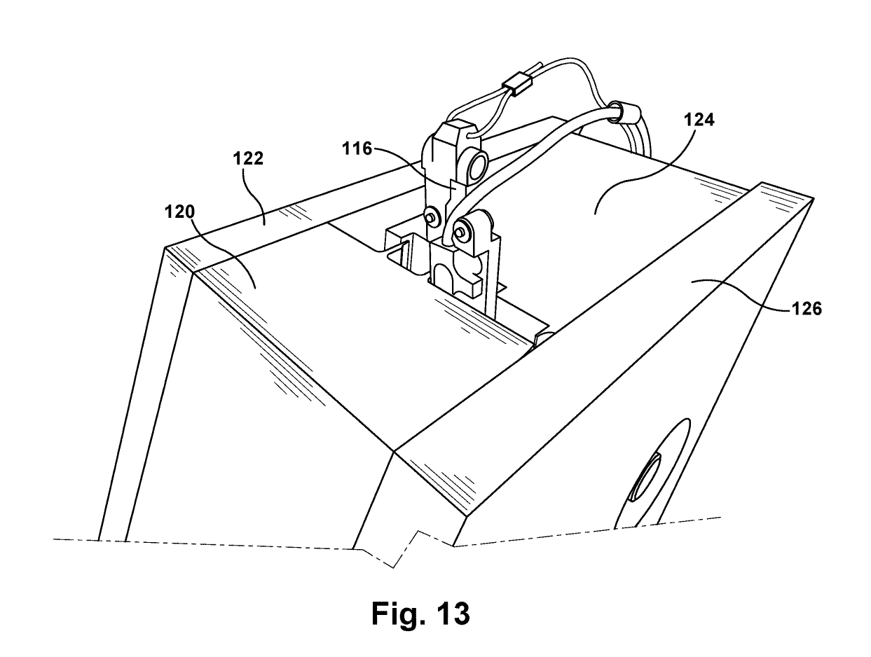

Referring to FIGS. 1, 12 and 13, a method for calibrating a concentricity measurement tool 116 such as an electronic radial alignment gauge configured to measure a concentricity deviation between a stator and a rotor of a rotary industrial machine will now be described. FIGS. 12 and 13 show two different forms of measurement tool 116 (e.g., radial alignment gauges of different sizes) and in two different locations between rotor simulating member 120 and stator simulating member 124. In a first step, measurement tool 116 is used to measure, at a selected circumferential position, a distance between rotor simulating member 120 and stator simulating member 124 that are positioned in a selected one of a plurality of predetermined concentricity positions relative to one another. As noted herein, each predetermined concentricity position creates a predetermined distance between rotor simulating member 120 and stator simulating member 124 at various circumferential positions. The selected circumferential position in FIGS. 12 and 13 is a circumferentially outermost location, but as understood, measurement tool 116 can be fed into the space between simulating members 120, 124 along test fixture 100 (FIG. 1) to test at any number of circumferential positions of test fixture 100 (FIG. 1). Based on the distance measured, controller 118 (FIG. 1) determines an amount of deviation between the distance measured and the predetermined distance. That is, a deviation between what is actually measured and what is expected to be measured. In addition, where text fixture 100 is in a non-concentric position, controller 118 identifies the deviation as measurement tool 116 measures different locations along the circumference, i.e., the radial distance measured should change along the circumference. The method may also include calibrating radial alignment gauge 116 using the amount(s) of deviation obtained, i.e., using any now known or later developed calibration algorithm. The method may also include repeating the measuring, determining and calibrating for a plurality of selected circumferential positions for the selected one of the plurality of predetermined concentricity positions, and/or a plurality of selected circumferential positions for a number of the plurality of predetermined concentricity positions. In the latter case, test fixture 100 would be adjusted to provide different predetermined non-concentricity arrangements. Once calibrated, in actual use, system 102 including concentricity measurement tool 116 and controller 118 would be employed at a number of circumferential positions in an actual rotary industrial machine, and the measurements obtained used to determine whether the rotor and stator of the machine are concentric.

Test fixture 100 and system 102 enable calibration and testing of concentricity measurement tools 116 for rotary industrial machine internals without interfering in an outage or installation process on-site. Further, the teachings of the disclosure provide the ability to test measurement tool prototypes prior to actual use and, if desired, prior to manufacture of the rotary industrial machines to which the tool will be applied. Since test fixture 100 and system 102 compare test results with actual misalignment and the geometry and conditions are close to the real parts in the field (controlled misalignment), they provide better data when determining and optimizing the tool accuracy compared to in-the-field calibration. Test fixture 100 can also be used for training purposes, and can be adjusted to provide practically any geometry of rotary industrial machine.

The foregoing description explains some of the processing according to several embodiments of this disclosure. It should be noted that in some alternative implementations, the acts noted may occur out of the order stated or, for example, may in fact be executed substantially concurrently or in the reverse order, depending upon the act involved.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A test fixture, comprising:
a rotor simulating member including a rotor mount;
a stator simulating member including a stator mount;
an adjustable positioner for positioning the rotor simulating member and the stator simulating member in a selected one of a plurality of predetermined concentricity positions relative to one another; and
a support for positioning the rotor simulating member and the stator simulating member on the ground.

2. The test fixture of claim 1, wherein the adjustable positioner includes:
a plurality of first fasteners selectively fastening the rotor mount to the stator simulating member, and
a plurality of second fasteners selectively fastening the stator mount to the rotor simulating member.

3. The test fixture of claim 2, wherein the adjustable positioner further includes:
a set of paired positioning openings in at least one of: a) the stator simulating member and the rotor mount, and b) the rotor simulating member and the stator mount, each pair of paired positioning openings defining a respective one of the plurality of predetermined concentricity positions of the rotor simulating member and the stator simulating member relative to one another;
a positioning member for selective positioning in a selected pair of the paired positioning openings to select a selected one of the predetermined concentricity positions of the rotor simulating member and the stator simulating member relative to one another.

4. The test fixture of claim 3, wherein the set of paired positioning openings includes a first set of paired positioning openings in a) the stator simulating member and the rotor mount, and a second set of paired positioning openings in b) the rotor simulating member and the stator mount, wherein corresponding pairs of each set of paired positioning openings cooperatively define the respective one of the plurality of predetermined concentricity positions of the rotor simulating member and the stator simulating member relative to one another, and
wherein the positioning member includes a first positioning member for selective positioning in the selected pair of the paired positioning openings in the first set and a second positioning member for selective positioning in the selected pair of positioning openings in the second set.

5. The test fixture of claim 2, wherein the adjustable positioner further includes:
a first adjustment member coupled to a selected one of the rotor simulating member and the stator simulating member;
a second adjustment member coupled to an opposing one of the stator mount and the rotor mount and in proximity to the first adjustment member;
a threaded distance adjuster selectively setting a distance between the first adjustment member and the second adjustment member; and
a threaded angle adjuster for selectively setting an angle between the first adjustment member and the second adjustment member,
wherein the threaded distance adjuster and the threaded angle adjuster cooperatively act to position the rotor simulating member and the stator simulating member in the selected one of a plurality of predetermined concentricity positions relative to one another.

6. The test fixture of claim 2, wherein the adjustable positioner further includes:
a first adjustment member coupled to a selected one of the rotor simulating member and the stator simulating member;
a second adjustment member coupled to an opposing one of the stator mount and the rotor mount and in proximity to the first adjustment member; and
at least one shim positioned between the first adjustment member and the second adjustment member to position the rotor simulating member and the stator simulating member in the selected one of a plurality of predetermined concentricity positions relative to one another.

7. The test fixture of claim 1, wherein the support includes a plurality of adjustable support legs.

8. The test fixture of claim 1, wherein the each simulating member includes a plurality of segments representing a part of a respective rotor or stator.

9. The test fixture of claim 8, wherein the each simulating member includes five 36° segments.

10. The test fixture of claim 1, wherein the plurality of predetermined concentricity positions includes a concentric position between the rotor simulating member and the stator simulating member, and at least one non-concentric position between the rotor simulating member and the stator simulating member.

11. The test fixture of claim 1, wherein each mount includes a plurality of fixedly coupled segments.

12. The test fixture of claim 1, wherein at least one of the stator simulating member and the rotor simulating member includes a seal simulating groove.

13. The test fixture of claim 1, wherein at least one of the rotor simulating member and the stator simulating member includes a set thereof, each set representing a different configuration of at least one of the rotor and the stator.

14. The test fixture of claim 1, further comprising a measurement tool configured to measure a concentricity deviation between the stator simulating member and the rotor simulating member.

15. The test fixture of claim 14, wherein the measurement tool includes an electronic radial alignment gauge and a controller therefor.

16. A system for calibrating a radial alignment gauge configured to measure a concentricity deviation between a stator and a rotor of a turbomachine, the system comprising:
a test fixture including:
a rotor simulating member including a rotor mount,
a stator simulating member including a stator mount,
an adjustable positioner for positioning the rotor simulating member and the stator simulating member in a selected one of a plurality of predetermined concentricity positions relative to one another, and
a support for positioning the rotor simulating member and the stator simulating member on the ground; and
a controller configured to calibrate the radial alignment gauge using the text fixture.

17. The system of claim 16, wherein the adjustable positioner includes:
a plurality of first fasteners selectively fastening the rotor mount to the stator simulating member;
a plurality of second fasteners selectively fastening the stator mount to the rotor simulating member;
a set of paired positioning openings in at least one of: a) the stator simulating member and the rotor mount, and b) the rotor simulating member and the stator mount, each pair of paired positioning openings defining a respective one of the plurality of predetermined concentricity positions of the rotor simulating member and the stator simulating member relative to one another;
a positioning member for selective positioning in a selected pair of the paired positioning openings to select a selected one of the predetermined concentricity positions of the rotor simulating member and the stator simulating member relative to one another.

18. The system of claim 17, wherein the set of paired positioning openings includes a first set of paired positioning openings in a) the stator simulating member and the rotor mount, and a second set of paired positioning openings in b) the rotor simulating member and the stator mount, wherein corresponding pairs of each set of paired positioning openings cooperatively define the respective one of the plurality of predetermined concentricity positions of the rotor simulating member and the stator simulating member relative to one another, and
wherein the positioning member includes a first positioning member for selective positioning in the selected pair of the paired positioning openings in the first set and a second positioning member for selective positioning in the selected pair of positioning openings in the second set.

19. The system of claim 16, wherein the adjustable positioner includes:
a plurality of first fasteners selectively fastening the rotor mount to the stator simulating member;
a plurality of second fasteners selectively fastening the stator mount to the rotor simulating member;
a first adjustment member coupled to a selected one of the rotor simulating member and the stator simulating member;
a second adjustment member coupled to an opposing one of the stator mount and the rotor mount and in proximity to the first adjustment member; and
a threaded distance adjuster selectively setting a distance between the first adjustment member relative to the second adjustment member; and
a threaded angle adjuster for selectively setting an angle between the first adjustment member and the second adjustment member,
wherein the threaded distance adjuster and the threaded angle adjuster cooperatively act to position the rotor simulating member and the stator simulating member in the selected one of a plurality of predetermined concentricity positions relative to one another.

20. The system of claim 16, wherein the adjustable positioner includes:
a plurality of first fasteners selectively fastening the rotor mount to the stator simulating member;
a plurality of second fasteners selectively fastening the stator mount to the rotor simulating member;
a first adjustment member coupled to a selected one of the rotor simulating member and the stator simulating member;
a second adjustment member coupled to an opposing one of the stator mount and the rotor mount and in proximity to the first adjustment member; and
at least one shim positioned between the first adjustment member and the second adjustment member to position the rotor simulating member and the stator simulating member in the selected one of a plurality of predetermined concentricity positions relative to one another.

21. A method for calibrating a concentricity measurement tool configured to measure a concentricity deviation between a stator and a rotor of a rotary industrial machine, the method comprising:
measuring, at a selected circumferential position and using the radial alignment gauge, a distance between a rotor simulating member and a stator simulating member that are positioned in a selected one of a plurality of predetermined concentricity positions relative to one another, each predetermined concentricity position creating a predetermined distance between the rotor simulating member and the stator simulating member at the selected circumferential position;
determining an amount of deviation between the distance measured and the predetermined distance; and
calibrating the radial alignment gauge using the amount of deviation.

22. The method of claim 21, further comprising repeating the measuring, determining and calibrating for at least one of:
a plurality of selected circumferential positions for the selected one of the plurality of predetermined concentricity positions, and
a plurality of selected circumferential positions for a number of the plurality of predetermined concentricity positions.
